(19) United States
(12) Patent Application Publication
(10) Pub. No.: US 2026/0339498 A1
(43) Pub. Date: Oct. 29, 2026

(54) AD HOC USER INTERFACES AND GENERATED USER INTERFACES BASED ON USER REQUESTS AND USER INTENT, AND TECHNIQUES AND SYSTEMS OF USE THEREOF

(71) Applicant: Meta Platforms Technologies, LLC, Menlo Park, CA (US)

(72) Inventors: Andrew Garrod Bosworth, San Mateo, CA (US); Matthew Alan Insley, Seattle, WA (US); Szeyin Lee, Seattle, WA (US); Philipp Schoessler, Scotts Valley, CA (US); Yasaman Sheri, San Francisco, CA (US)

(21) Appl. No.: 19/649,019

(22) Filed: Apr. 15, 2026

Related U.S. Application Data
(60) Provisional application No. 63/794,295, filed on Apr. 24, 2025.

(51) Int. Cl. G06F 3/04847; G06F 3/0482; G06F 3/16

(52) U.S. Cl. CPC G06F 3/04847; G06F 3/0482; G06F 3/167

(57) ABSTRACT

A method of interacting for presenting ad hoc user interfaces (UIs) to a user of a head-wearable device is described. The method includes, in response to a request, from the user, to perform tasks, causing UI elements to be generated. The UI elements is associated with a default display position. The method further includes, in accordance with a determination that a hand of the user is within a field-of-view of the user, determining a hand location of the hand of the user, wherein the hand location is distinct from the default display position. The method further includes causing displays of the head-wearable device to present the UI elements at the hand location. The method further includes, in accordance with a determination that the user performs a hand movement with the hand, causing the tasks to be performed, based on the hand movement.

### RELATED APPLICATION

This application claims priority to U.S. Provisional Application Serial No. 63/794,295, filed Apr. 24, 2025, entitled “Ad Hoc User Interfaces And Generated User Interfaces Based On User Requests And User Intent, And Techniques And Systems Of Use Thereof,” which is incorporated herein by reference.

### TECHNICAL FIELD

This relates generally to techniques for generating and presenting user interfaces (UIs) at one or more displays of an extended-reality (XR) headset.

### BACKGROUND

Artificially intelligent (AI) assistants make user interactions with systems and applications more convenient. Often, the easiest way a user can communicate information to the AI assistant is through a user interface (UI) rather than voice commands or text inputs. But most tasks a user will ask the AI assistant to execute do not have a predefined or ready-made UI that the user can interact with to accomplish the task. Additionally, some tasks may require multiple UIs or a sequence of UIs that the user interacts with in order to the accomplish the task. An AI assistant should be able to make it easier for the user to accomplish their desired tasks in fast and seamless manner.

Voice interactions are a convenient way to interact with wearable computing devices, but they have shortcomings. Prominently, voice interactions lack granular control. Vocal interactions with AI assistants often rely on predefined commands or phrases, which may not provide the necessary granularity for precise control. For example, a voice command like "turn up the volume" might increase the volume by a fixed amount, but it may not allow for precise adjustments. Additionally, trying to accomplish more complex tasks with voice is very hard due to lack of precision and feedback. Further, AI assistants do not always understand the context in which a command is given. For instance, if a user says, “scale the window,” the AI assistant may not know which window the user wants to scale.

As such, there is a need to address one or more of the above-identified challenges. A brief summary of solutions to the issues noted above are described below.

### SUMMARY

One example of a first method for presenting generated UI elements to a user is described herein. This first method occurs at a head-wearable device (e.g., an extended-reality XR headset) with one or more displays and/or one or more microphones. In some embodiments, the method occurs while the head-wearable device is worn by a user, and the head-wearable device is associated with a predefined set of UI elements. The first method includes, in response to a request (e.g., a voice command, a hand gesture, a touch input, and/or a gaze gesture), from the user, to perform one or more tasks (e.g., sending photos to friends and/or creating a music playlist), determine whether the one or more tasks can be performed using the predefined set of UI elements. The first method further includes, in accordance with a determination that the one or more tasks cannot be performed using the predefined set of UI elements, cause a machine-learning algorithm (e.g., a multi-modal AI) to generate one or more generated UI elements based on the request. The first method further includes, causing the one or more generated UI elements to be presented to the user at one or more displays of the head-wearable device. The first method further includes, in response to one or more user inputs (e.g., a voice command, a hand gesture, a touch input, and/or a gaze gesture) directed at the one or more generated UI elements, causing the one or more tasks to be performed.

Another example of a second method for presenting ad hoc UI elements to a user is described herein. This second method occurs at a head-wearable device (e.g., an extended-reality XR headset) with one or more displays and/or one or more microphones. In some embodiments, the second method occurs while the head-wearable device is worn by a user. In some embodiments, the second method includes, in response to a request (e.g., a voice command, a hand gesture, a touch input, and/or a gaze gesture), from the user, to perform one or more tasks (e.g., change an output volume of the head-wearable device and/or change an opacity of XR content displayed at the head-wearable device), causing one or more UI elements to be generated. The one or more UI elements is associated with a default display position (e.g., a bottom portion of the user’s field-of-view). The second method further includes, in accordance with a determination that a hand of the user is within a field-of-view of the user, determining a hand location (e.g., a location of the user’s hand in the user’s field-of-view) of the hand of the user, wherein the hand location is distinct from the default display position. The second method further includes causing one or more displays of the head-wearable device to present the one or more UI elements at the hand location. The second method further includes, in accordance with a determination that the user performs a hand movement (e.g., a hand slide movement) with the hand, causing the one or more tasks to be performed, based on the hand movement.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1D illustrate a user interacting with a first generated user interface (UI) at a head-wearable device based on a first voice command, in accordance with some embodiments.

FIGS. 2A-2D illustrate a user interacting with a second generated UI at a head-wearable device based on a second voice command, in accordance with some embodiments.

FIGS. 3A-3E illustrate a user interacting with one or more ad hoc UI elements at a head-wearable device based on a request, in accordance with some embodiments.

FIGS. 4A-4B illustrate example method flow charts for presenting generated UI elements and ad hoc UI elements to a user, in accordance with some embodiments.

FIGS. 5A, 5B, 5C-1, and 5C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user’s physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user’s hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user’s possession (e.g., smartphones, laptops, imaging devices, intermediary devices, and/or other devices described herein).

The input modalities as alluded to above can be varied and are dependent on a user’s experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user’s heart rate; (v) peripheral oxygen saturation (SpO₂) sensors for measuring blood oxygen saturation and/or other biometric data of a user; (vi) capacitive sensors for detecting changes in potential at a portion of a user’s body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user’s environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Generative User Interfaces And Ad Hoc User Interfaces

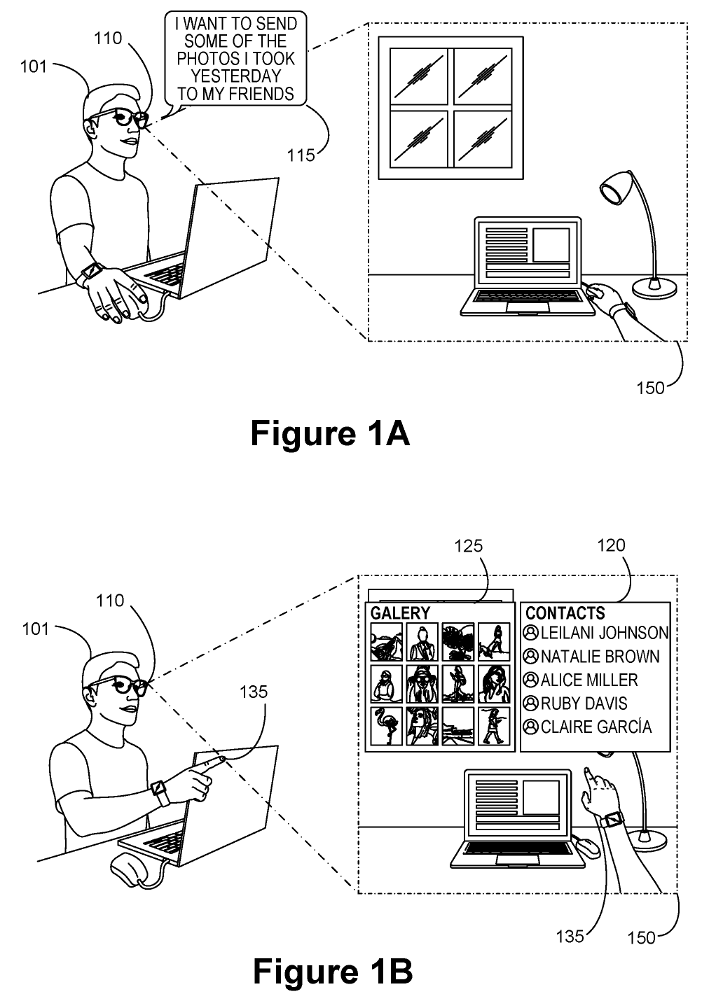

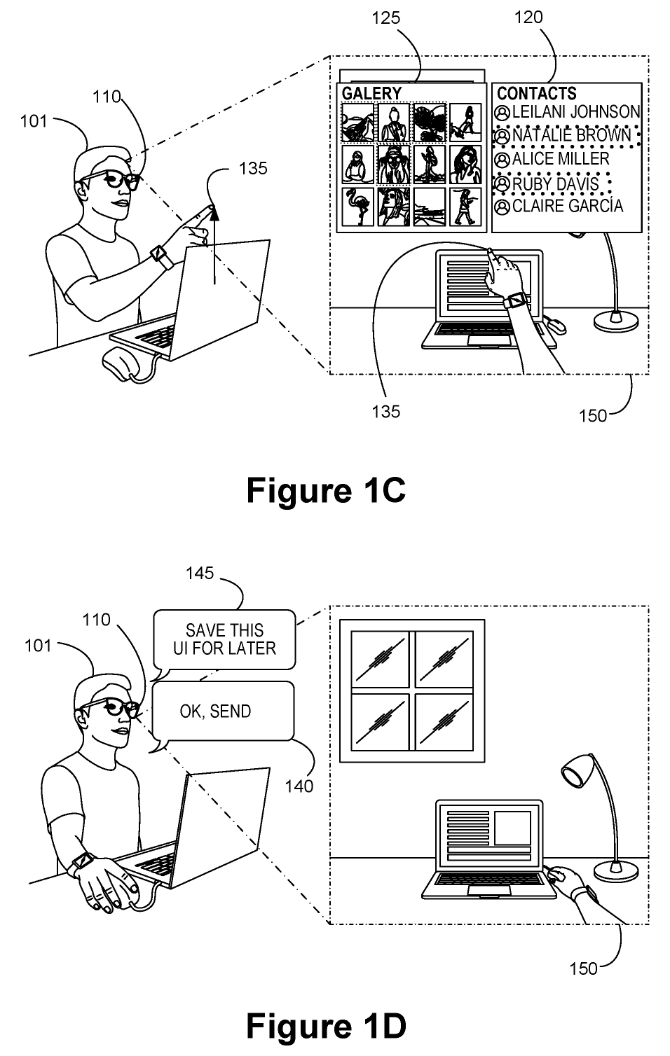

FIGS. 1A-3E illustrate a user 101 interacting with a plurality of generated user interfaces (UIs), in accordance with some embodiments. FIGS. 1A-3E illustrate the plurality of generated UIs being presented to the user 101 at one or more displays of a head-wearable device 110 (e.g., an extended-reality (XR) headset, a pair of smart glasses, an XR hat, and/or XR contacts), but this should not be construed as limiting the performance of the operation to the particular device in all embodiments. Generated UIs and ad hoc UIs described in reference to FIGS. 1A-3E may be presented to the user 101 at other devices (e.g., wrist-wearable devices, smartphones, tablets, personal computers, televisions, etc.), and the user 101 may interact with the generated UIs and ad hoc UIs by providing inputs at the other devices. In some embodiments, the head-wearable device 110 is communicatively coupled to another device (e.g., a smart watch, a smartphone, a personal computer, a handheld intermediary processing device, a server, etc.). The head-wearable device 110 and/or the other device includes one or more processors for executing operations related to an artificially intelligent assistant, one or more operations related to a machine-learning algorithm, and/or one or more other operations related to the head-wearable device 110 and/or the other device. In some embodiments, the head-wearable device 110 includes the one or more displays for presenting one or more UI elements to the user 101. In some embodiments, the head-wearable device 110 and/or the other device includes one or more microphones for capturing audio data one or more voice commands performed by the user 101. In some embodiments, the head-wearable device 110 includes one or more forward-facing cameras for capturing image data of a field-of-view 150 of the user 101 and one or more inertial measurement unit (IMU) sensors for capturing biopotential data one or more head movements performed by the user. A gaze gestures and/or a gaze location (e.g., a location within the field-of-view 150 that the user 101 is looking at) may be determined based on the image data of the field-of-view 150 and the biopotential data of the one or more head movements. In some embodiments, the head-wearable device 110 includes one or more eye-tracking cameras for capturing eye-tracking data that may be used to determine the gaze gesture and/or the gaze location. In some embodiments, the one or more forward-facing cameras capture image gesture data including one or both hands of the user 101 in the field-of-view 150. In some embodiments, the other device (e.g., a smart watch) includes one or more biopotential sensors (e.g., an IMU sensor and/or an electromyography (EMG) sensor) for detecting hand biopotential data of the one or both hands of the user 101. One or more hand gestures and/or one or more hand movements, performed by the user 101, may be determined based on the image gesture data and/or the hand biopotential data.

FIGS. 1A-1D illustrate the user 101 interacting with a first generated user interface (UI) at the head-wearable device 110 based on a first voice command 115, in accordance with some embodiments. FIG. 1A illustrates the user 101 performing a first request, such as the first voice command 115 (e.g., “I want to send some of the photos I took yesterday to my friends.”). The voice command 115 is detected at the one or more microphones, and a multi-modal artificial intelligence (AI) determines one or more first tasks (e.g., send one or more photos to one or more contacts) to be performed, based on the first request. In accordance with a determination that the one or more first tasks requires additional inputs and/or additional information (e.g., which of the one or more photos and which of the one or more contacts) to complete the one or more first tasks, prepare one or more prompts to present to the user 101 that prompts the user 101 to provide the additional inputs and/or the additional information. If the one or more prompts cannot be presented to the user 101 using a predefined set of UI elements, the multi-modal AI generates a first generated UI that prompts the user 101 to provide the additional inputs and/or the additional information.

FIG. 1B illustrates the first generated UI presented to the user 101 at the one or more displays of the head-wearable device 110, in accordance with some embodiments. The first generated UI includes one or more first generated UI elements. For example, FIG. 1B illustrates the first generated UI including a first generated UI element 120 (e.g., a list of contacts, as illustrated in FIG. 1B) and a second UI element 125 (e.g., a list of recent photos, as illustrated in FIG. 1B). In some embodiments, each of the one or more first generated UI elements includes one or more respective sub-elements (e.g., each contact in the list of contacts and/or each photo in the list of recent photos) that are selectable and allow the user 101 to interact with the one or more first generated UI elements. In some embodiments, each of the one or more first generated UI elements is configured to accomplish one or more first subtasks of the one or more first tasks. For example, the first generated UI element 120 is configured to prompt the user 101 to select one or more contacts from the list of contacts, and the second generated UI element 125 is configured to prompt the user 101 to select one or more photos from the list of recent photos. In some embodiments, the one or more first generated UI elements are generated based on the one or more first tasks, the first request, one or more user preferences, one or more previous interactions with generated UIs, and/or a predicted intent of the user 101. In some embodiments, at least one of the one or more first generated UI elements is selected from the list of predefined UI elements.

FIG. 1C illustrates the user 101 interacting with the first generated UI, in accordance with some embodiments. The user 101 may perform one or more first user inputs to interact with the first generated UI. The one or more first user inputs includes one or more hand gestures 135 (e.g., pointing at a sub-element of the one or more first generated UI elements, as illustrated in FIG. 1C), one or more gaze gestures (e.g., holding a gaze at the sub-element of the one or more first generated UI elements), and/or one or more voice commands (e.g., “Send the photos to Alice and Ruby.”). In some embodiments, the one or more first generated UI elements are updated based on the one or more first user inputs. For example, FIG. 1C illustrates two contacts of the list of contacts and four of the photos of the list of recent photos as highlighted in response to the user 101 performing the one or more first user inputs (e.g., pointing at one of the contacts and/or one or of the photos and performing an index pinch gesture) to select the two contacts and the four photos.

FIG. 1D illustrates the multi-modal AI performing the one or more tasks in response to the one or more user inputs, in accordance with some embodiments. In accordance with a determination (e.g., by the multi-modal AI) that the user 101 has provided the additional inputs and/or the additional information such that the multi-modal AI can complete the one or more first tasks, the multi-modal AI performs the one or more first tasks (e.g., sends the four photos to the two contacts) and/or causes the one or more first tasks to be performed. In some embodiments, the determination that the user 101 has provided the additional inputs and/or the additional information such that the multi-modal AI can complete the one or more first tasks includes a determination that the user 101 has performed a completion command. In some embodiments, the completion command includes a second voice command 140 (e.g., “Ok, send.”), one or more second gaze gestures, and/or one or more second hand gestures (e.g., a double finger-pinch gesture). Additionally, in accordance with the determination that the user 101 has provided the additional inputs and/or the additional information such that the multi-modal AI can complete the one or more first tasks the head-wearable device 110 ceases presenting the first generated UI, as illustrated in FIG. 1D. In some embodiments, the head-wearable device 110 further presents a confirmation cue (e.g., an audio cue, such as a tone and/or an audio response “Photos sent,” and/or a visual cue, such as a notification “Photos sent.”) to the user 101 to inform the user 101 that the one or more first tasks are being performed and/or the one or more first tasks have been performed. In some embodiments, the user 101 may add the first generated UI to the list of predefined UI elements by performing a save input 145 (e.g., a save voice command “Save this UI for later,” a save hand gesture, a save touch input, and/or selecting a save option presented to the user 101 with the first generated UI).

In some embodiments, the first generated UI element 120 and the second generated UI element 125 are presented simultaneously, as illustrated in FIGS. 1B-1C. In some embodiments, the first generated UI element 120 and the second generated UI element 125 are presented sequentially. For example, in response to the first request, the head-wearable device presents the first generated UI with only the first generated UI element 120, and, after the user 101 has selected one or more contacts from the list of contacts, the first generated UI is modified to no longer show the first generated UI element 120 and show the second generated UI element 125.

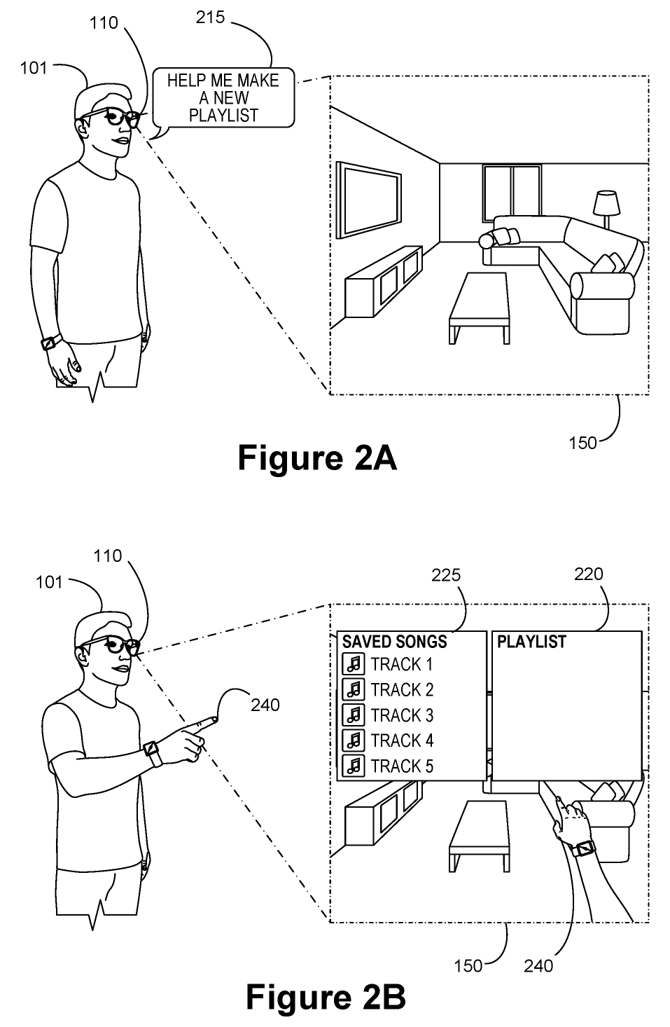

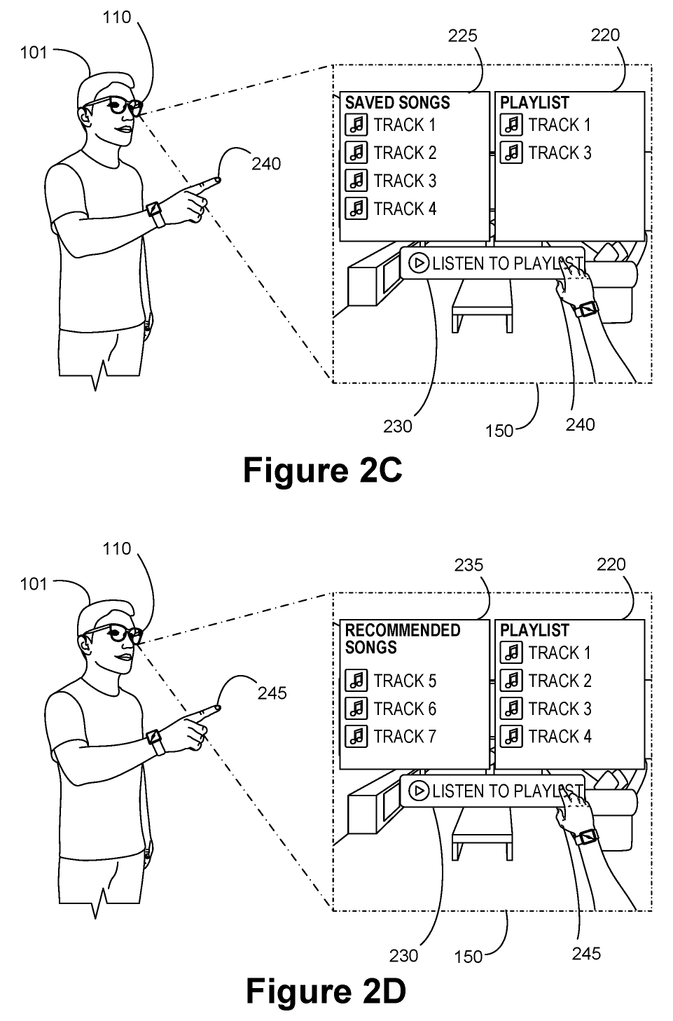

FIGS. 2A-2D illustrate the user 101 interacting with a second generated UI at the head-wearable device 110 based on a second voice command 215, in accordance with some embodiments. FIG. 2A illustrates the user 101 performing a second request, such as the second voice command 215 (e.g., “Help me make a new playlist.”). The multi-modal AI determines one or more second tasks (e.g., create a new music playlist) to be performed, based on the second request. In accordance with a determination that the one or more second tasks require additional inputs and/or additional information (e.g., what songs to add to the new music playlist) to complete the one or more second tasks, prepare one or more second prompts to present to the user 101 that prompts the user 101 to provide the additional inputs and/or the additional information. If the one or more second prompts cannot be presented to the user 101 using the predefined set of UI elements, the multi-modal AI generates a second generated UI that prompts the user 101 to provide the additional inputs and/or the additional information.

FIG. 2B illustrates the second generated UI presented to the user 101 at the one or more displays of the head-wearable device 110, in accordance with some embodiments. The second generated UI includes one or more second generated UI elements. For example, FIG. 2B illustrates the second generated UI including a third generated UI element 220 (e.g., a list of saved songs, as illustrated in FIG. 2B) and a fourth generated UI element 225 (e.g., an empty playlist, as illustrated in FIG. 2B). In some embodiments, each of the one or more second generated UI elements are configured to accomplish one or more second subtasks of the one or more second tasks. For example, the third generated UI element 220 is configured to prompt the user 101 to select one or more songs from the list of saved songs, and the fourth generated UI element 225 is configured to prompt the user 101 to add one or more songs to the new playlist. In some embodiments, the one or more second generated UI elements are generated based on the one or more second tasks, the second request, the one or more user preferences, the one or more previous interactions with generated UIs, and/or another predicted intent of the user 101. In some embodiments, at least one of the one or more second generated UI elements is selected from the list of predefined UI elements.

FIG. 2C illustrates the user 101 the second generated UI updating as the user 101 interacts with the second generated UI, in accordance with some embodiments. The user 101 may perform one or more second user inputs to interact with the second generated UI. The one or more second user inputs include one or more second hand gestures 240 (e.g., pointing at a sub-element of the one or more second generated UI elements, as illustrated in FIG. 2C), one or more gaze gestures, and/or one or more voice commands (e.g., “Add track 3 to the new playlist.”). In some embodiments, the one or more second generated UI elements are updated based on the one or more second user inputs. For example, FIG. 2C illustrates two songs of the list of saved songs in the new playlist in response to the user 101 performing the one or more second user inputs to select the two songs (e.g., by performing one or more drag-and-drop gestures). In response to the user 101 performing the one or more second user inputs, the multi-modal AI modifies the second generated UI by adding an additional generated UI element 230 (e.g., an audio player UI element to play audio from the new playlist) to the second generated UI. In some embodiments, the additional generated UI element 230 is configured to accomplish an additional subtask of the one or more second tasks (e.g., previewing audio from the new playlist). In some embodiments, the additional generated UI element 230 is generated by the multi-modal AI. In some embodiments, the additional generated UI element 230 is generated based on the one or more second tasks, the second request, the one or more second user inputs, the one or more second generated UI elements, the one or more user preferences, the one or more previous interactions with generated UIs, and/or another predicted intent of the user 101. For example, in response to the user 101 adding one or more songs to the new playlist, the multi-modal AI generates the additional generated UI element 230 and updates the second generated UI to include the additional generated UI element 230, as illustrated in FIG. 2C.

FIG. 2D illustrates the user 101 the second generated UI further updating as the user 101 continues to interact with the second generated UI, in accordance with some embodiments. The user 101 may perform one or more additional user inputs (e.g., one or more additional hand gestures 245) to continue interacting with the second generated UI. In response to the user 101 performing the one or more additional user inputs, the multi-modal AI modifies the second generated UI by removing at least one of the one or more second generated UI elements from the second generated UI (e.g., the third generated UI element 220, the fourth generated UI element, and/or the additional generated UI element 230). In some embodiments, when the at least one of the one or more second generated UI elements is removed from the second generated UI, another generated UI element 235 (e.g., a list of recommended songs, as illustrated in FIG. 2D) is added to the second generated UI. In some embodiments, the other generated UI element 235 is configured to accomplish another subtask of the one or more second tasks (e.g., recommend songs for the new playlist). In some embodiments, the other generated UI element 235 is generated by the multi-modal AI. In some embodiments, the other generated UI element 235 is generated based on the one or more second tasks, the second request, the one or more second user inputs, the one or more additional user inputs, the one or more second generated UI elements, the additional generated UI element, the one or more user preferences, the one or more previous interactions with generated UIs, and/or another predicted intent of the user 101. For example, in response to the user 101 adding additional songs to the new playlist, the multi-modal AI generates the other generated UI element 235 and updates the second generated UI to no longer include the fourth generated UI element 225 and include the additional generated UI element 230, as illustrated in FIG. 2D. In accordance with a determination (e.g., by the multi-modal AI) that the user 101 has provided the additional inputs and/or the additional information (e.g., by performing one or more other user inputs directed at the second generated UI) such that the multi-modal AI can complete the one or more second tasks, the multi-modal AI performs the one or more second tasks (e.g., creates the new playlist) and/or causes the one or more second tasks to be performed.

In some embodiments, the multi-modal AI modifies the second generated UI in accordance with a determination that modifying the second generated UI will assist the user 101 in providing the additional inputs and/or the additional information (e.g., displaying the audio player UI element will allow the user 101 to listen to songs in the new playlist and/or displaying the list of recommended songs will help the user 101 select songs to add to the new playlist). In some embodiments, the additional generated UI element and/or the other generated UI element is based on the one or more second user inputs and/or the one or more additional user inputs (e.g., the list of recommended songs is based on the songs the user 101 has added to the new playlist).

In accordance with some embodiments, the multi-modal AI system generates a respective generated UI based on user-intended objectives (as determined by the multi-modal AI) that the user 101 is likely to perform (e.g., based on past user behaviors) and/or has requested assistance to perform. After generating the respective generated UI, the multi-modal AI may qualify, measure, and/or validate rates of completion of the user-intended objectives based on interactions with the respective generated UI. For example, based on using the multi-modal AI to determine one or more predicted tasks that the user 101 is intending to accomplish, use data gathering during subsequent user interactions with the subsequent generated UI to determine whether the user 110 completed performance of the one or more predicted tasks.

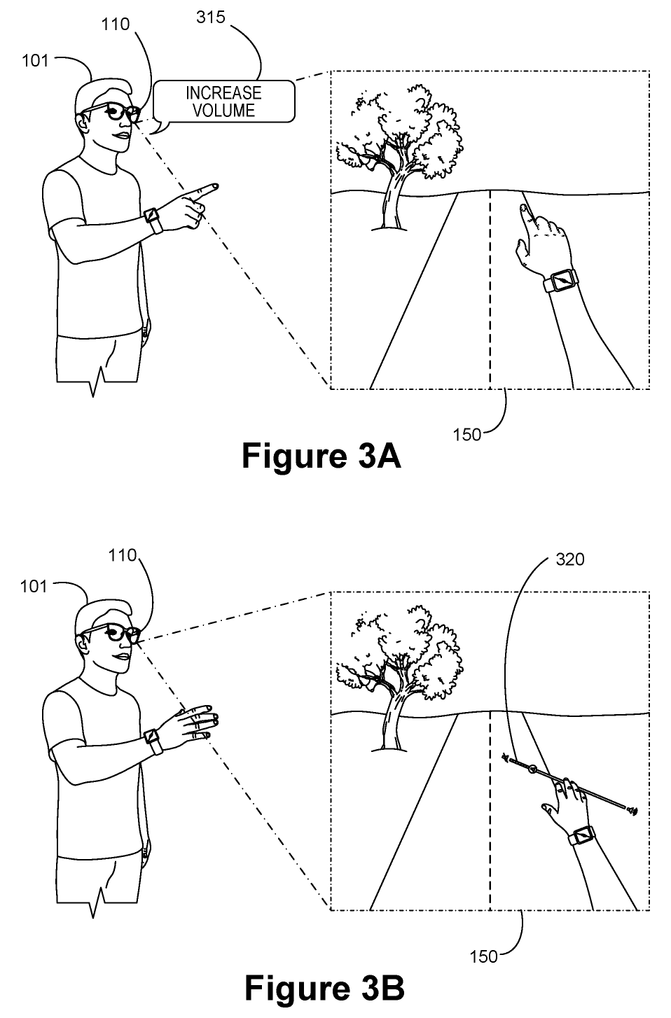

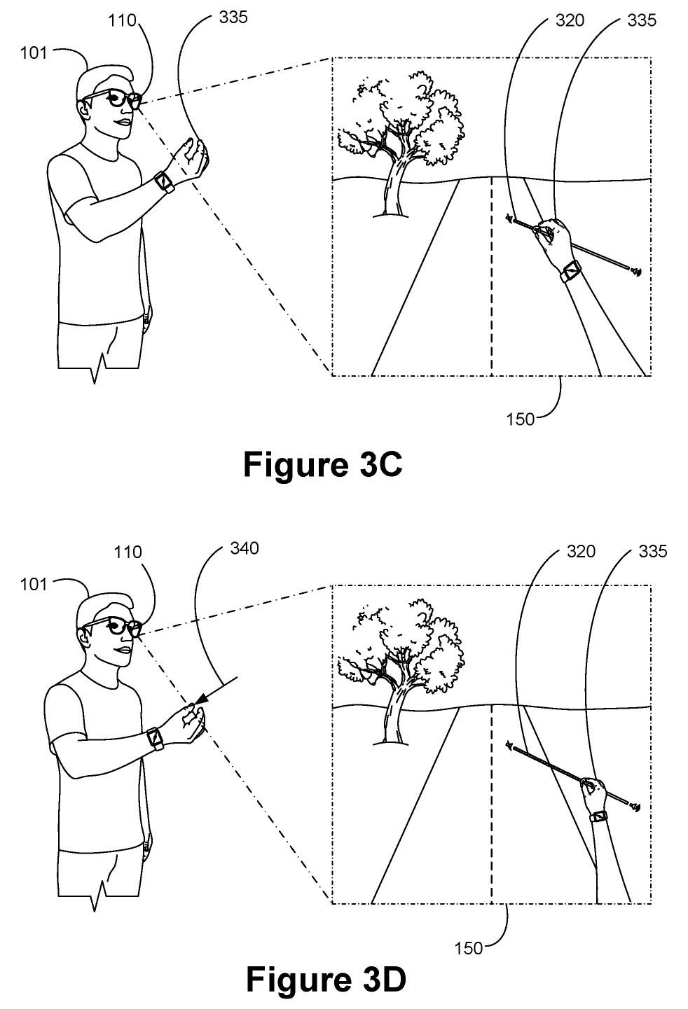

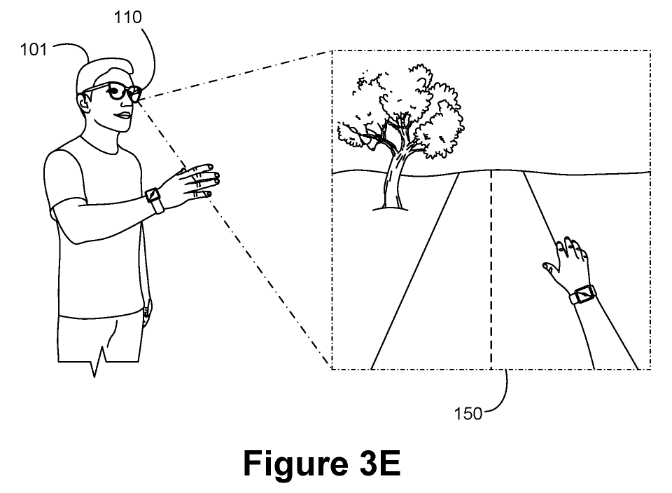

FIGS. 3A-3E illustrate the user 101 interacting with one or more ad hoc UI elements 320 at the head-wearable device 110 based on a third request, in accordance with some embodiments. FIG. 3A illustrates the user 101 performing the third request while a hand of the user 101 is within the field-of-view 150 of the user 101, in accordance with some embodiments. In some embodiments, the third request is one or more of a third voice command 315 (e.g., “Increase volume.”), a third hand gesture (e.g., a snap finger gesture), a third touch input and/or a third gaze gesture. The multi-modal AI determines one or more third tasks (e.g., increase an output volume of the head-wearable device 110) to be performed based on the third request, one or more user preferences, one or more previous interactions with ad hoc UI elements, and/or a predicted intent of the user 101. In accordance with a determination that the hand of the user 101 is within the field-of-view 150 of the user 101 when the user 101 performs the third request, the head-wearable device 110 presents the one or more ad hoc UI elements 320 at the one or more displays of the head-wearable device 110. The one or more ad hoc UI elements 320 is generated, by the multi-modal AI, based on the third request and/or the one or more third tasks. In some embodiments, the head-wearable device 110 presents the one or more ad hoc UI elements 320 in accordance with a further determination that one or more follow-up inputs from the user 101 are required to complete the one or more third tasks. For example, in response to the third voice command 315 “Increase volume,” it is unclear by how much the user 101 desires to increase the output volume of the head-wearable device 110, and thus causes a volume-slider ad hoc UI element to be presented to allow the user 101 to choose a volume level.

FIG. 3B illustrates the one or more ad hoc UI elements 320 presented at a hand location in the field-of-view 150 of the user 101, in accordance with some embodiments. The hand location is determined based on image data captured by the one or more cameras of the head-wearable device 110. In some embodiments, the one or more ad hoc UI elements 320 is associated with a default display location in the field-of-view 150 (e.g., a bottom portion of the field-of-view 150, a side portion of the field-of-view 150, a center portion of the field-of-view 150, etc.) and a default display orientation (e.g., perpendicular to the field-of-view 150). In accordance with a determination that the hand location of the hand of the user 101 is not at the default display location, the one or more ad hoc UI elements 320 is presented at the hand location, as illustrated in FIG. 3B. In some embodiments, the one or more ad hoc UI elements 320 is presented with a second display orientation (e.g., appearing diagonally, as illustrated in FIG. 3B), distinct from the default display orientation, based on the hand location. As an example, in response to the third request and in accordance with the determination that the hand of the user 101 is within the field-of-view 150, the head-wearable device 110 presents the one or more ad hoc UI elements 320 at the hand location and with a perspective such that the one or more ad hoc UI elements 320 appears at an angle askew to the user 101 rather than perpendicular to the user 101, as illustrated in FIG. 3B. In some embodiments, in response to the third request and in accordance with a determination that the hand of the user 101 is not within the field-of-view 150, the head-wearable device 110 displays the one or more ad hoc UI elements at the default display location and with the default display orientation.

FIGS. 3C-3D illustrate the user 101 interacting with the one or more ad hoc UI elements 320, in accordance with some embodiments. The user 101 interact with the one or more ad hoc UI elements 320 by performing one or more interaction hand gestures and/or one or more interaction hand movements directed at the one or more ad hoc UI elements 320. For example, as illustrated in FIG. 3C, the user 101 performs a pinch gesture 335 directed the one or more ad hoc UI elements 320 (e.g., a select knob of a volume slider) to select the one or more ad hoc UI elements 320. As another example, as illustrated in FIG. 3D, the performs a slide hand movement 340 directed at the one or more ad hoc UI elements 320 (e.g., moving the select knob of the volume slider) to manipulate the one or more ad hoc UI elements 320. In response to the one or more interaction hand gestures and/or the one or more interaction hand movements, the one or more ad hoc UI elements 320 are modified based on the one or more interaction hand gestures and/or the one or more interaction hand movements (e.g., moving the select knob along the volume slider). In response to the one or more interaction hand gestures and/or the one or more interaction hand movements, the multi-modal AI and/or the head-wearable device 110 performs and/or causes performance of the one or more third tasks (e.g., increasing the output volume of the head-wearable device 110 to 70%). In some embodiments, the user 101 performs a first hand gesture (e.g., the pinch gesture 335) to select the one or more ad hoc UI elements 320, and the user 101 holds the first hand gesture while performing a second hand movement (e.g., the slide hand movement 340) to manipulate the one or more ad hoc UI elements 320, as illustrated in FIGS. 3C-3D.

FIG. 3E illustrates the head-wearable device 110 ceasing to display the one or more ad hoc UI elements 320, in accordance with some embodiments. The head-wearable device 110 ceases displaying the one or more ad hoc UI elements 320 in response to the user 101 ceasing to perform the one or more interaction hand gestures and/or the one or more interaction hand movements. For example, as illustrated in FIG. 3E, the user 101 releases the pinch gesture 335 after performing the slide hand movement 340, and the head-wearable device 110 ceases displaying in response. In some embodiments, the multi-modal AI and/or the head-wearable device 110 performs and/or causes performance of the one or more third tasks in response to the user 101 ceasing to perform the one or more interaction hand gestures and/or the one or more interaction hand movements (e.g., the multi-modal AI and/or the head-wearable device 110 waits until the user 101 has ceased performing the input to perform the one or more third tasks).

In another embodiment, the user 101 makes a fourth request by performing a fourth hand gesture (e.g., a middle finger pinch gesture). The multi-modal AI determines one or more fourth tasks (e.g., change an opacity of extended-reality (XR) content presented of the head-wearable device 110) to be performed based on the fourth request, one or more user preferences, one or more previous interactions with ad hoc UI elements, and/or a predicted intent of the user 101. In accordance with a determination that the hand of the user 101 is within the field-of-view 150 of the user 101 when the user 101 performs the fourth request, the head-wearable device 110 presents the one or more additional ad hoc UI elements (e.g., an opacity slider UI element) at an additional hand location of the hand of the user 101. The additional hand location is determined based on image data captured by the one or more cameras of the head-wearable device 110. The user 101 then performs one or more additional hand movements (e.g., sliding the hand along the opacity slider UI element) while continuing to hold the fourth hand gesture. In response to the user 101 performing the one or more additional hand movements, the multi-modal AI and/or head-wearable device 110 performs and/or causes performance of the one or more fourth tasks (e.g., changing the opacity of the XR elements based on the one or more additional hand movements). In response to the user 101 releasing the fourth hand gesture, the head-wearable device 110 ceases displaying the one or more additional ad hoc UI elements.

In some embodiments, the one or more ad hoc UI elements 320 is generated by the multi-modal AI, and/or the one or more ad hoc UI elements 320 includes one or more predefined ad hoc UI elements. The one or more predefined ad hoc UI elements includes a slider UI element (e.g., horizontal, vertical, discrete and/or continuous), a two-dimensional picker UI element (e.g., an red-green-blue color picker), a three-dimensional rotation gizmo UI element, a binary switch UI element, a rotatable knob UI element, a scrollable list UI element, a media player UI element (e.g., an audio player UI element and/or a video player UI element), a text editor UI element, an application status interface UI element, and/or a system status interface UI element (e.g., a list of running applications). In some embodiments, the one or more hand movements and/or the one or more hand gestures include a hand slide movement (e.g., horizontal, vertical, diagonal, etc.), a hand swipe movement, a drag-and-drop movement, a pinch-and-turn movement, a flick movement, a button-press movement, a wrist-roll movement, a typing movement, and/or a drawing movement. In some embodiments, the one or more third tasks includes increasing and/or decreasing an output volume of the head-wearable device 110 and/or another device, scaling and/or resizing an application window displayed at the head-wearable device 110 and/or the other device, changing a display position of another application window displayed at the head-wearable device 110 and/or the other device, changing a passthrough opacity of one or more XR elements displayed at the head-wearable device 110, presenting a list of recently used applications at the head-wearable device 110 and/or the other device, changing a color of the one or more XR elements displayed at the head-wearable device 110, changing an input volume of one or more microphones of the head-wearable device 110 and/or the other device, and/or editing and/or selecting text displayed at the head-wearable device 110 and/or the other device.

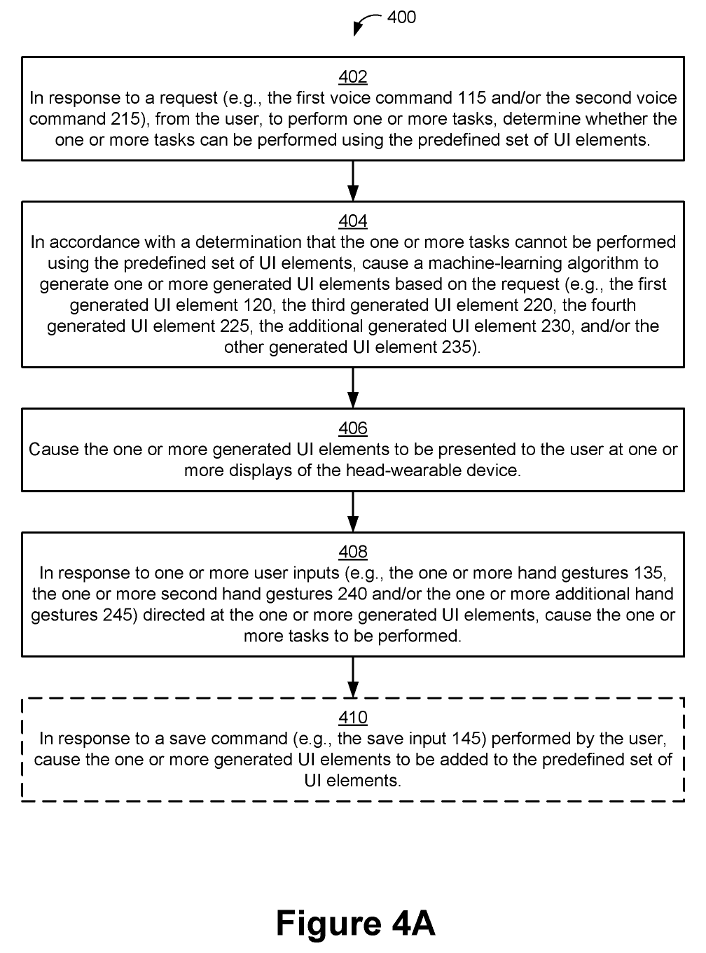

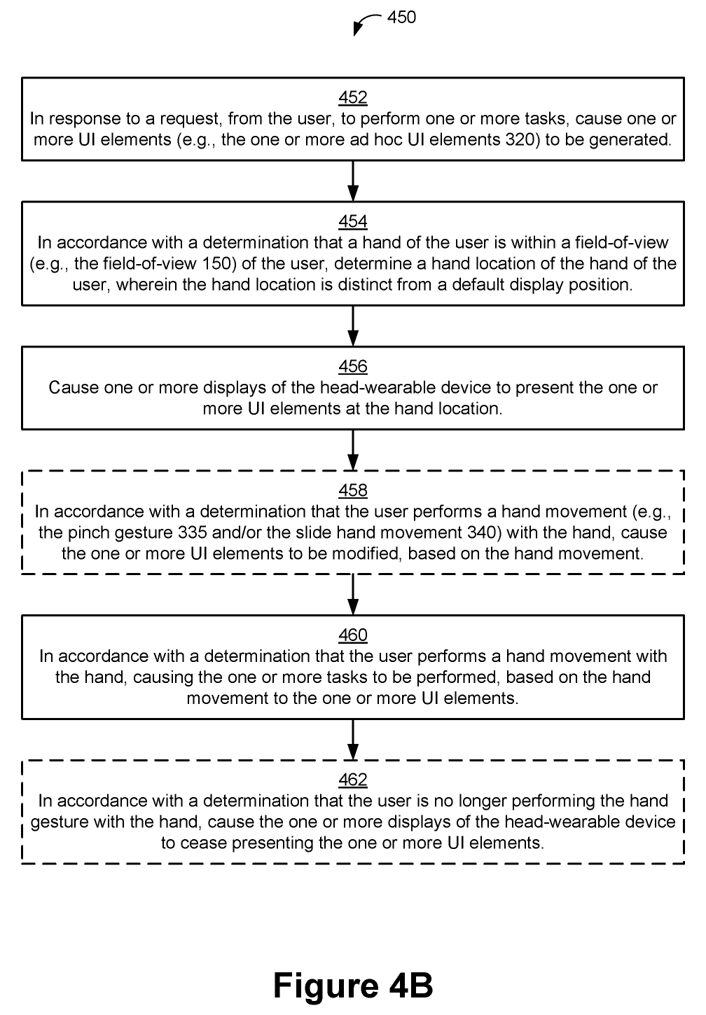

FIG. 4A illustrates a flow diagram of a method 400 of presenting generated UI elements to a user (e.g., the user 101), in accordance with some embodiments. FIG. 4B illustrates a flow diagram of a method 450 of presenting ad hoc UI elements to the user, in accordance with some embodiments. Operations (e.g., steps) of the method 400 and the method 450 can be performed by one or more processors (e.g., central processing unit and/or MCU) of a system including a head-wearable device (e.g., the head-wearable device 110) and/or one or more other devices communicatively coupled to the head-wearable device. At least some of the operations shown in FIGS. 4A-4B correspond to instructions stored in a computer memory or computer-readable storage medium (e.g., storage, RAM, and/or memory). Operations of the method 400 and the method 450 can be performed by a single device alone or in conjunction with one or more processors and/or hardware components of another communicatively coupled device and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device but should not be construed as limiting the performance of the operation to the particular device in all embodiments.

(A1) FIG. 4A shows a flow chart of a method 400 of presenting generated UI elements to a user, in accordance with some embodiments.

The method 400 occurs at a head-wearable device (e.g., the head-wearable device 110) with one or more displays and/or one or more microphones. In some embodiments, the method 400 occurs while the head-wearable device is worn by a user (e.g., the user 101), and the head-wearable device is associated with a predefined set of UI elements (e.g., the predefined set of UI elements described in reference to FIGS. 1A-2D). The method 400 includes, in response to a request (e.g., the first request, such as the first voice command 115, and/or the second request, such as the second voice command 215), from the user, to perform one or more tasks (e.g., the one or more first tasks and/or the one or more second tasks), determine whether the one or more tasks can be performed using the predefined set of UI elements (402). The method 400 further includes, in accordance with a determination that the one or more tasks cannot be performed using the predefined set of UI elements, cause a machine-learning algorithm (e.g., the multi-modal AI) to generate one or more generated UI elements (e.g., the first generated UI element 120, the second generated UI element 125 the third generated UI element 220, the fourth generated UI element 225, the additional generated UI element 230, and/or the other generated UI element 235) based on the request (404). The method 400 further includes, causing the one or more generated UI elements to be presented to the user at one or more displays of the head-wearable device (e.g., the one or more displays of the head-wearable device 110) (406). The method 400 further includes, in response to one or more user inputs (e.g., the one or more first user inputs, the one or more second user inputs, and/or the one or more additional user inputs) directed at the one or more generated UI elements, causing the one or more tasks to be performed (408).

(A2) In some embodiments of A1 each of the one or more generated UI elements is configured to perform a respective subtask (e.g., the one or more first subtasks, the one or more second subtasks, the additional subtask, and/or the other subtask) of the one or more tasks.

(A3) In some embodiments of any of A1-A2, the method 400 further includes, after causing the one or more generated UI elements to be presented to the user at the one or more displays of the head-wearable device and in response to a save command (e.g., the save input 145) performed by the user, causing the one or more generated UI elements to be added to the predefined set of UI elements (410).

(A4) In some embodiments of any of A1-A3, the machine-learning algorithm further generates the one or more generated UI elements based on previous interactions between the user and one or more previous generated UI elements (e.g., the first generated UI element 120, the third generated UI element 220, the fourth generated UI element 225, and/or the additional generated UI element 230).

(A5) In some embodiments of any of A1-A4, the machine-learning algorithm further generates the one or more generated UI elements based on a predicted intent of the user.

(A6) In some embodiments of any of A1-A5, the one or more generated UI elements include at least a first generated UI element (e.g., the third generated UI element 220 and/or the fourth generated UI element 225) and a second generated UI element (e.g., the additional generated UI element 230 and/or the other generated UI element 235). Also, causing the one or more generated UI elements to be presented to the user at the one or more displays of the head-wearable device includes: (i) causing the first generated UI element to be presented to the user at the one or more displays of the head-wearable device and (ii), in response to one or more first user inputs (e.g., the one or more second user inputs, as described in reference to FIG. 2B, and/or the one or more additional user inputs) directed at the first generated UI element, causing the second generated UI element to be presented to the user at the one or more displays of the head-wearable device. Furthermore, causing the one or more tasks to be performed is in response to one or more second user inputs directed at the second generated UI element and the one or more first user inputs directed at the first generated UI element.

(A7) In some embodiments of any of A1-A6, the machine-learning algorithm further generates the second generated UI elements based on the one or more first user inputs directed at the first generated UI element.

(A8) In some embodiments of any of A1-A7, the one or more generated UI elements include at least a first generated UI element (e.g., the first generated UI element 120 and/or the third generated UI element 220) and a second generated UI element (e.g., the second generated UI element 125 and/or the fourth generated UI element 225). Also, causing the one or more generated UI elements to be presented to the user at the one or more displays of the head-wearable device includes causing the first generated UI element and the second generated UI element to simultaneously be presented to the user at the one or more displays of the head-wearable device. Additionally, causing the one or more tasks to be performed is in response to the one or more user inputs (e.g., the one or more first user inputs and/or the one or more second user inputs) directed at the first generated UI element and/or second generated UI element.

(A9) In some embodiments of any of A1-A8, the method 400 further includes, in response to the one or more user inputs directed at the one or more generated UI elements, determining one or more additional tasks to be performed. The method 400 further includes, in accordance with a determination that the one or more additional tasks cannot be performed using the predefined set of UI elements, causing the machine-learning algorithm to generate one or more additional generated UI elements (e.g., the additional generated UI element 230 and/or the other generated UI element 235) based on the one or more additional tasks. The method 400 further includes causing the one or more additional generated UI elements to be presented to the user at one or more displays of the head-wearable device. The method 400 further includes, in response to one or more additional user inputs (e.g., the one or more additional user inputs and/or the one or more other user inputs) directed at the one or more additional generated UI elements, cause the one or more additional tasks to be performed.

(A10) In some embodiments of any of A1-A9, the machine-learning algorithm further generates the additional generated UI elements based on the one or more first user inputs directed at the first generated UI element.

(A11) In some embodiments of any of A1-A10, the method 400 further includes, in response to another request (e.g., the first request, such as the first voice command 115, and/or the second request, such as the second voice command 215), from the user, to perform one or more other tasks (e.g., the one or more first tasks and/or the one or more second tasks), determining whether the one or more other tasks can be performed using the predefined set of UI elements. The method 400 further includes, in accordance with a determination that the one or more other tasks cannot be performed using the predefined set of UI elements, causing the machine-learning algorithm to generate one or more other generated UI elements (e.g., the first generated UI element 120, the second generated UI element 125 the third generated UI element 220, the fourth generated UI element 225, the additional generated UI element 230, and/or the other generated UI element 235) based on the other request. The method 400 further includes causing the one or more other generated UI elements to be presented to the user at the one or more displays of the head-wearable device. The method 400 further includes, in response to one or more other user inputs (e.g., the one or more first user inputs, the one or more second user inputs, and/or the one or more additional user inputs) directed at the one or more other generated UI elements, causing the one or more other tasks to be performed.

(A12) In some embodiments of any of A1-A11, determining whether the one or more tasks can be performed using the predefined set of UI elements is performed by another machine-learning algorithm (e.g., the multi-modal AI).

(A13) In some embodiments of any of A1-A12, each of the one or more generated UI elements is a respective type of UI element of a plurality of UI element types.

(A14) In some embodiments of any of A1-A13, the plurality of UI types includes a slider, a knob, a scrollable list, a switch, a selection display, a three-dimensional rotator, a media player, and/or an application status interface.

(B1) FIG. 4B shows a flow chart of the method 450 of presenting ad hoc UI elements to a user, in accordance with some embodiments.

The method 450 occurs at a head-wearable device (e.g., the head-wearable device 110) with one or more displays and/or one or more microphones. In some embodiments, the method 400 occurs while the head-wearable device is worn by a user (e.g., the user 101). In some embodiments, the method 450 includes, in response to a request (e.g., the third request, as described in reference to FIGS. 3A-3E), from the user, to perform one or more tasks (e.g., the one or more third tasks), causing one or more UI elements (e.g., the one or more ad hoc UI elements 320) to be generated (452). The one or more UI elements is associated with a default display position (e.g., the default display location in the field-of-view 150 and/or the default display orientation, as described in reference to FIGS. 3A-3E). The method 450 further includes, in accordance with a determination that a hand of the user is within a field-of-view (e.g., the field-of-view 150) of the user, determining a hand location (e.g., the hand location in the field-of-view 150) of the hand of the user, wherein the hand location is distinct from the default display position (454). The method 450 further includes causing one or more displays of the head-wearable device to present the one or more UI elements at the hand location (456). The method 450 further includes, in accordance with a determination that the user performs a hand movement (e.g., the pinch gesture 335 and/or the slide hand movement 340) with the hand, causing the one or more tasks to be performed (e.g., changing the output volume of the head-wearable device 110), based on the hand movement (410).

(B2) In some embodiments of B1, the method 450 further includes, in accordance with a determination that the user performs a hand movement with the hand, causing the one or more UI elements to be modified (e.g., moving the select knob along the volume slider, as described in reference to FIGS. 3C-3D), based on the hand movement (458). Also, causing the one or more tasks to be performed is further based on the modification to the one or more UI elements.

(B3) In some embodiments of any of B1-B2, the one or more UI elements is generated in accordance with a determination that additional information (e.g., how much the user 101 desires to increase the output volume of the head-wearable device 110) is required to complete the one or more tasks.

(B4) In some embodiments of any of B1-B3, causing the one or more tasks to be performed is further in accordance with a determination that the user is performing a hand gesture (e.g., the pinch gesture 335) with the hand.

(B5) In some embodiments of any of B1-B4, the method 450 further includes, after the user performs the hand movement with the hand and in accordance with a determination that the user is no longer performing the hand gesture with the hand, cause the one or more displays of the head-wearable device to cease presenting the one or more UI elements (e.g., as described in reference to FIG. 3E) (462).

(B6) In some embodiments of any of B1-B5, the one or more user UI elements are generated by a machine-learning algorithm (e.g., the multi-modal AI) based on the request and/or the one or more tasks.

(B7) In some embodiments of any of B1-B6, the head-wearable device is associated with a predefined set of UI elements (e.g., the one or more predefined ad hoc UI elements). Additionally, the method 450 further includes, in response to the request to perform the one or more tasks and before generating the one or more UI elements: (i) determine whether the one or more tasks can be performed using the predefined set of UI elements and (ii), in accordance with a determination that the one or more tasks cannot be performed using the predefined set of UI elements, cause the machine-learning algorithm to generate the one or more UI elements based on the request.

(B8) In some embodiments of any of B1-B7, the method 450 further includes in response to another request (e.g., the fourth hand gesture), from the user, to perform one or more other tasks (e.g., the one or more fourth tasks), causing one or more other UI elements (e.g., the one or more additional ad hoc UI elements) to be generated. The method 450 further includes, in accordance with a determination that the hand of the user is within the field-of-view of the user, determining another hand location (e.g., the additional hand location) of the hand of the user. The method 450 further includes causing the one or more displays of the head-wearable device to present the one or more other UI elements at the other hand location. The method 450 further includes, in accordance with a determination that the user performs another hand movement (e.g., the one or more additional hand movements) with the hand, cause the one or more other UI elements to be modified, based on the other hand movement.

(B9) In some embodiments of any of B1-B8, the method 450 further includes, after generating the one or more UI elements and in accordance with a determination that a second hand of the user is within the field-of-view of the user, determining a second hand location of the second hand of the user. The method 450 further includes causing the one or more displays of the head-wearable device to present the one or more other UI elements at the hand location and/or the second hand location. The method 450 further includes, in accordance with a determination that the user performs the hand movement with the hand and/or a second hand movement with the second hand, causing the one or more other UI elements to be modified, based on the hand movement and/or the second hand movement.

(B10) In some embodiments of any of B1-B9, the request to perform the one or more tasks is a voice command performed by the user.

(B11) In some embodiments of any of B1-B10, the one or more UI elements includes a slider, a knob, a scrollable list, a switch, a selection display, a three-dimensional rotator, a media player, and/or an application status interface.

(C1) In accordance with some embodiments, a non-transitory computer readable storage medium including instructions that, when executed by a computing device in communication with a pair of extended-reality (XR) glasses (e.g., the head-wearable device), cause the computing device to perform operations corresponding to any of A1-B11.

(D1) In accordance with some embodiments, means for performing or causing performance of the operations corresponding to any of A1-B11.

(E1) In accordance with some embodiments, a head-wearable device (e.g., the head-wearable device 110) for performing or causing performance of the operations corresponding to any of A1-B11.

(F1) In accordance with some embodiments, an intermediary processing device (e.g., configured to offload processing operations for a head-worn device such as extended-reality (XR) glasses) configured to perform or cause performance of the operations corresponding to any of A1-B11.

(G1) In accordance with some embodiments, a system that includes a pair of extended-reality (XR) glasses, and the system is configured to perform operations corresponding to any of A1-B11.

### Example Extended-Reality Systems

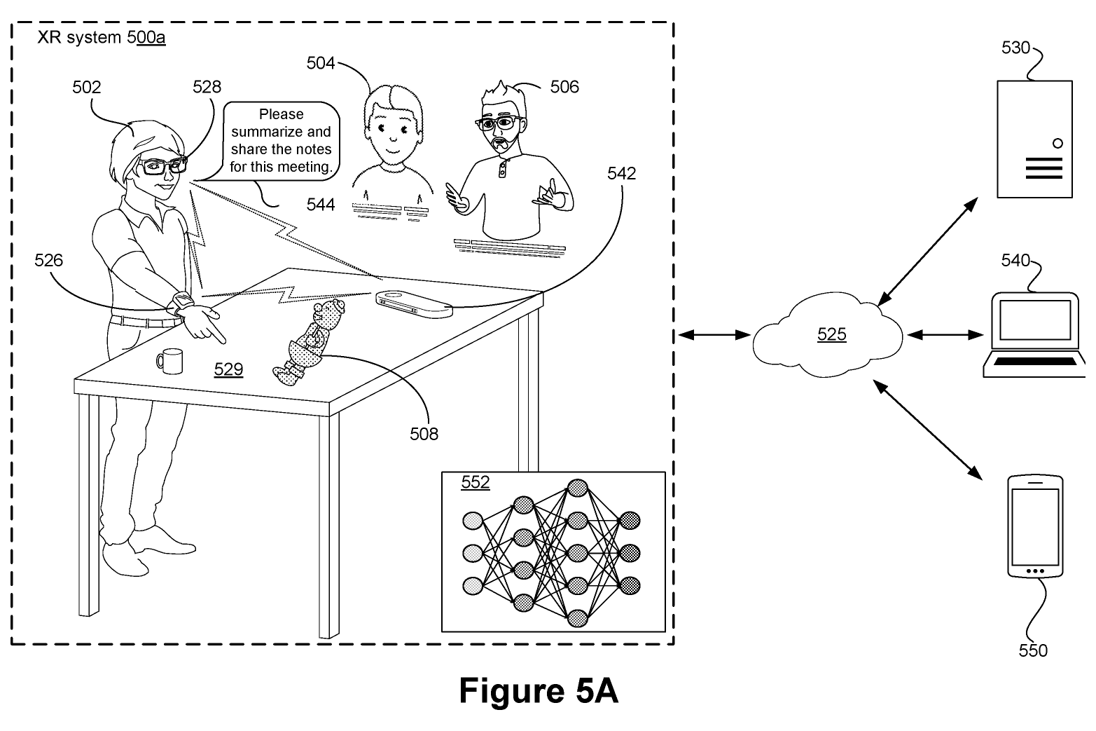

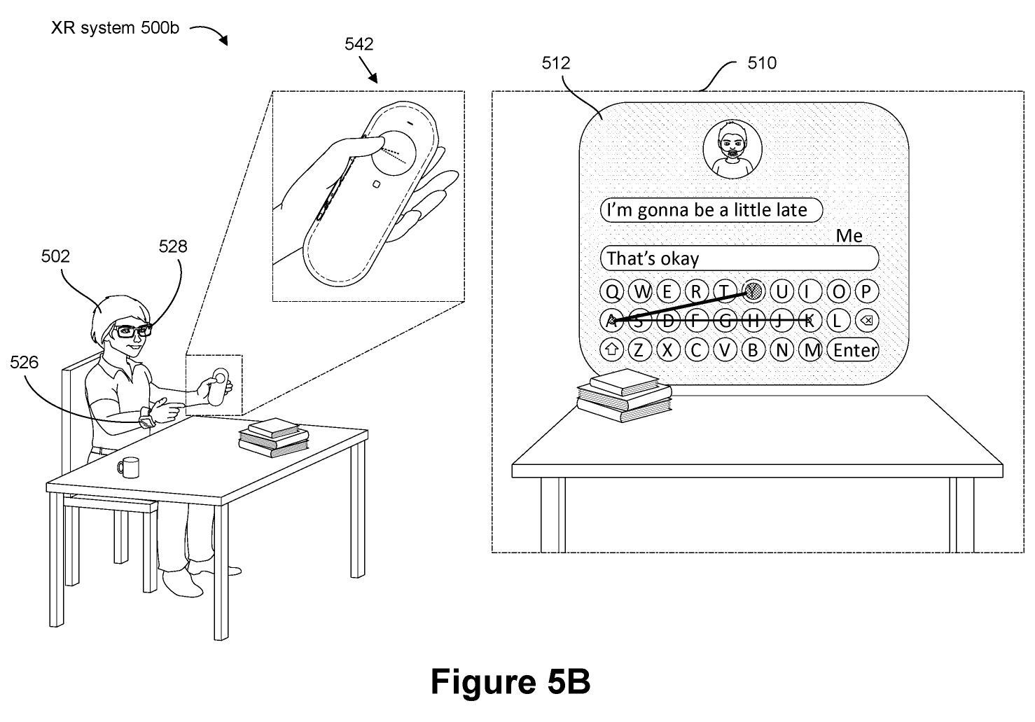

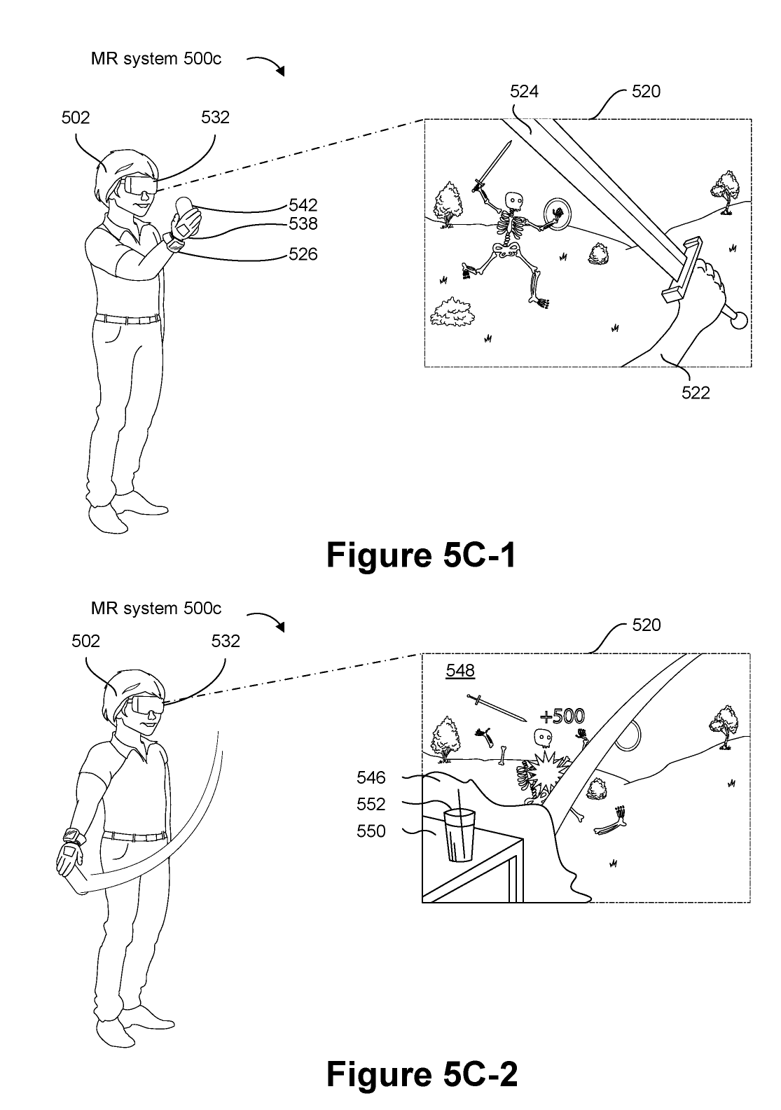

FIGS. 5A, 5B, 5C-1, and 5C-2, illustrate example XR systems that include AR and MR systems, in accordance with some embodiments. FIG. 5A shows a first XR system 500a and first example user interactions using a wrist-wearable device 526, a head-wearable device (e.g., AR device 528), and/or a HIPD 542. FIG. 5B shows a second XR system 500b and second example user interactions using a wrist-wearable device 526, AR device 528, and/or an HIPD 542. FIGS. 5C-1 and 5C-2 show a third MR system 500c and third example user interactions using a wrist-wearable device 526, a head-wearable device (e.g., an MR device such as a VR device), and/or an HIPD 542. As the skilled artisan will appreciate upon reading the descriptions provided herein, the above-example AR and MR systems (described in detail below) can perform various functions and/or operations.

The wrist-wearable device 526, the head-wearable devices, and/or the HIPD 542 can communicatively couple via a network 525 (e.g., cellular, near field, Wi-Fi, personal area network, wireless LAN). Additionally, the wrist-wearable device 526, the head-wearable device, and/or the HIPD 542 can also communicatively couple with one or more servers 530, computers 540 (e.g., laptops, computers), mobile devices 550 (e.g., smartphones, tablets), and/or other electronic devices via the network 525 (e.g., cellular, near field, Wi-Fi, personal area network, wireless LAN). Similarly, a smart textile-based garment, when used, can also communicatively couple with the wrist-wearable device 526, the head-wearable device(s), the HIPD 542, the one or more servers 530, the computers 540, the mobile devices 550, and/or other electronic devices via the network 525 to provide inputs.

Turning to FIG. 5A, a user 502 is shown wearing the wrist-wearable device 526 and the AR device 528 and having the HIPD 542 on their desk. The wrist-wearable device 526, the AR device 528, and the HIPD 542 facilitate user interaction with an AR environment. In particular, as shown by the first AR system 500a, the wrist-wearable device 526, the AR device 528, and/or the HIPD 542 cause presentation of one or more avatars 504, digital representations of contacts 506, and virtual objects 508. As discussed below, the user 502 can interact with the one or more avatars 504, digital representations of the contacts 506, and virtual objects 508 via the wrist-wearable device 526, the AR device 528, and/or the HIPD 542. In addition, the user 502 is also able to directly view physical objects in the environment, such as a physical table 529, through transparent lens(es) and waveguide(s) of the AR device 528. Alternatively, an MR device could be used in place of the AR device 528 and a similar user experience can take place, but the user would not be directly viewing physical objects in the environment, such as table 529, and would instead be presented with a virtual reconstruction of the table 529 produced from one or more sensors of the MR device (e.g., an outward facing camera capable of recording the surrounding environment).

The user 502 can use any of the wrist-wearable device 526, the AR device 528 (e.g., through physical inputs at the AR device and/or built-in motion tracking of a user’s extremities), a smart-textile garment, externally mounted extremity tracking device, the HIPD 542 to provide user inputs, etc. For example, the user 502 can perform one or more hand gestures that are detected by the wrist-wearable device 526 (e.g., using one or more EMG sensors and/or IMUs built into the wrist-wearable device) and/or AR device 528 (e.g., using one or more image sensors or cameras) to provide a user input. Alternatively, or additionally, the user 502 can provide a user input via one or more touch surfaces of the wrist-wearable device 526, the AR device 528, and/or the HIPD 542, and/or voice commands captured by a microphone of the wrist-wearable device 526, the AR device 528, and/or the HIPD 542. The wrist-wearable device 526, the AR device 528, and/or the HIPD 542 include an artificially intelligent digital assistant to help the user in providing a user input (e.g., completing a sequence of operations, suggesting different operations or commands, providing reminders, confirming a command). For example, the digital assistant can be invoked through an input occurring at the AR device 528 (e.g., via an input at a temple arm of the AR device 528). In some embodiments, the user 502 can provide a user input via one or more facial gestures and/or facial expressions. For example, cameras of the wrist-wearable device 526, the AR device 528, and/or the HIPD 542 can track the user 502’s eyes for navigating a user interface.

The wrist-wearable device 526, the AR device 528, and/or the HIPD 542 can operate alone or in conjunction to allow the user 502 to interact with the AR environment. In some embodiments, the HIPD 542 is configured to operate as a central hub or control center for the wrist-wearable device 526, the AR device 528, and/or another communicatively coupled device. For example, the user 502 can provide an input to interact with the AR environment at any of the wrist-wearable device 526, the AR device 528, and/or the HIPD 542, and the HIPD 542 can identify one or more back-end and front-end tasks to cause the performance of the requested interaction and distribute instructions to cause the performance of the one or more back-end and front-end tasks at the wrist-wearable device 526, the AR device 528, and/or the HIPD 542. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 542 can perform the back-end tasks and provide the wrist-wearable device 526 and/or the AR device 528 operational data corresponding to the performed back-end tasks such that the wrist-wearable device 526 and/or the AR device 528 can perform the front-end tasks. In this way, the HIPD 542, which has more computational resources and greater thermal headroom than the wrist-wearable device 526 and/or the AR device 528, performs computationally intensive tasks and reduces the computer resource utilization and/or power usage of the wrist-wearable device 526 and/or the AR device 528.

In the example shown by the first AR system 500a, the HIPD 542 identifies one or more back-end tasks and front-end tasks associated with a user request to initiate an AR video call with one or more other users (represented by the avatar 504 and the digital representation of the contact 506) and distributes instructions to cause the performance of the one or more back-end tasks and front-end tasks. In particular, the HIPD 542 performs back-end tasks for processing and/or rendering image data (and other data) associated with the AR video call and provides operational data associated with the performed back-end tasks to the AR device 528 such that the AR device 528 performs front-end tasks for presenting the AR video call (e.g., presenting the avatar 504 and the digital representation of the contact 506).

In some embodiments, the HIPD 542 can operate as a focal or anchor point for causing the presentation of information. This allows the user 502 to be generally aware of where information is presented. For example, as shown in the first AR system 500a, the avatar 504 and the digital representation of the contact 506 are presented above the HIPD 542. In particular, the HIPD 542 and the AR device 528 operate in conjunction to determine a location for presenting the avatar 504 and the digital representation of the contact 506. In some embodiments, information can be presented within a predetermined distance from the HIPD 542 (e.g., within five meters). For example, as shown in the first AR system 500a, virtual object 508 is presented on the desk some distance from the HIPD 542. Similar to the above example, the HIPD 542 and the AR device 528 can operate in conjunction to determine a location for presenting the virtual object 508. Alternatively, in some embodiments, presentation of information is not bound by the HIPD 542. More specifically, the avatar 504, the digital representation of the contact 506, and the virtual object 508 do not have to be presented within a predetermined distance of the HIPD 542. While an AR device 528 is described working with an HIPD, an MR headset can be interacted with in the same way as the AR device 528.

User inputs provided at the wrist-wearable device 526, the AR device 528, and/or the HIPD 542 are coordinated such that the user can use any device to initiate, continue, and/or complete an operation. For example, the user 502 can provide a user input to the AR device 528 to cause the AR device 528 to present the virtual object 508 and, while the virtual object 508 is presented by the AR device 528, the user 502 can provide one or more hand gestures via the wrist-wearable device 526 to interact and/or manipulate the virtual object 508. While an AR device 528 is described working with a wrist-wearable device 526, an MR headset can be interacted with in the same way as the AR device 528.

### Integration of Artificial Intelligence with XR Systems

FIG. 5A illustrates an interaction in which an artificially intelligent virtual assistant can assist in requests made by a user 502. The AI virtual assistant can be used to complete open-ended requests made through natural language inputs by a user 502. For example, in FIG. 5A the user 502 makes an audible request 544 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 5A also illustrates an example neural network 552 used in Artificial Intelligence applications. Uses of Artificial Intelligence (AI) are varied and encompass many different aspects of the devices and systems described herein. AI capabilities cover a diverse range of applications and deepen interactions between the user 502 and user devices (e.g., the AR device 528, an MR device 532, the HIPD 542, the wrist-wearable device 526). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user’s request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 502 can interact with an AI model through natural language inputs captured by a voice sensor, text inputs, or any other input modality that accepts natural language and/or a corresponding voice sensor module. In another instance, input is provided by tracking the eye gaze of a user 502 via a gaze tracker module. Additionally, the AI model can also receive inputs beyond those supplied by a user 502. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 528) or from multiple devices that are in communication with each other (e.g., a system that includes at least two of an AR device 528, an MR device 532, the HIPD 542, the wrist-wearable device 526, etc.). The AI model can also access additional information (e.g., one or more servers 530, the computers 540, the mobile devices 550, and/or other electronic devices) via a network 525.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 528, an MR device 532, the HIPD 542, the wrist-wearable device 526) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 528, an MR device 532, the HIPD 542, the wrist-wearable device 526), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 542), haptic feedback can provide information to the user 502. An AI model can also use the inputs described above to determine the appropriate modality and device(s) to present content to the user (e.g., a user walking on a busy road can be presented with an audio output instead of a visual output to avoid distracting the user 502).

### Example Augmented Reality Interaction

FIG. 5B shows the user 502 wearing the wrist-wearable device 526 and the AR device 528 and holding the HIPD 542. In the second AR system 500b, the wrist-wearable device 526, the AR device 528, and/or the HIPD 542 are used to receive and/or provide one or more messages to a contact of the user 502. In particular, the wrist-wearable device 526, the AR device 528, and/or the HIPD 542 detect and coordinate one or more user inputs to initiate a messaging application and prepare a response to a received message via the messaging application.

In some embodiments, the user 502 initiates, via a user input, an application on the wrist-wearable device 526, the AR device 528, and/or the HIPD 542 that causes the application to initiate on at least one device. For example, in the second AR system 500b the user 502 performs a hand gesture associated with a command for initiating a messaging application (represented by messaging user interface 512); the wrist-wearable device 526 detects the hand gesture; and, based on a determination that the user 502 is wearing the AR device 528, causes the AR device 528 to present a messaging user interface 512 of the messaging application. The AR device 528 can present the messaging user interface 512 to the user 502 via its display (e.g., as shown by user 502’s field of view 510). In some embodiments, the application is initiated and can be run on the device (e.g., the wrist-wearable device 526, the AR device 528, and/or the HIPD 542) that detects the user input to initiate the application, and the device provides another device operational data to cause the presentation of the messaging application. For example, the wrist-wearable device 526 can detect the user input to initiate a messaging application, initiate and run the messaging application, and provide operational data to the AR device 528 and/or the HIPD 542 to cause presentation of the messaging application. Alternatively, the application can be initiated and run at a device other than the device that detected the user input. For example, the wrist-wearable device 526 can detect the hand gesture associated with initiating the messaging application and cause the HIPD 542 to run the messaging application and coordinate the presentation of the messaging application.

Further, the user 502 can provide a user input provided at the wrist-wearable device 526, the AR device 528, and/or the HIPD 542 to continue and/or complete an operation initiated at another device. For example, after initiating the messaging application via the wrist-wearable device 526 and while the AR device 528 presents the messaging user interface 512, the user 502 can provide an input at the HIPD 542 to prepare a response (e.g., shown by the swipe gesture performed on the HIPD 542). The user 502’s gestures performed on the HIPD 542 can be provided and/or displayed on another device. For example, the user 502’s swipe gestures performed on the HIPD 542 are displayed on a virtual keyboard of the messaging user interface 512 displayed by the AR device 528.

In some embodiments, the wrist-wearable device 526, the AR device 528, the HIPD 542, and/or other communicatively coupled devices can present one or more notifications to the user 502. The notification can be an indication of a new message, an incoming call, an application update, a status update, etc. The user 502 can select the notification via the wrist-wearable device 526, the AR device 528, or the HIPD 542 and cause presentation of an application or operation associated with the notification on at least one device. For example, the user 502 can receive a notification that a message was received at the wrist-wearable device 526, the AR device 528, the HIPD 542, and/or other communicatively coupled device and provide a user input at the wrist-wearable device 526, the AR device 528, and/or the HIPD 542 to review the notification, and the device detecting the user input can cause an application associated with the notification to be initiated and/or presented at the wrist-wearable device 526, the AR device 528, and/or the HIPD 542.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 528 can present to the user 502 game application data and the HIPD 542 can use a controller to provide inputs to the game. Similarly, the user 502 can use the wrist-wearable device 526 to initiate a camera of the AR device 528, and the user can use the wrist-wearable device 526, the AR device 528, and/or the HIPD 542 to manipulate the image capture (e.g., zoom in or out, apply filters) and capture image data.

While an AR device 528 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user’s hand or other suitable surface (e.g., a table, whiteboard). In yet another embodiment, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 5C-1 and 5C-2, the user 502 is shown wearing the wrist-wearable device 526 and an MR device 532 (e.g., a device capable of providing either an entirely VR experience or an MR experience that displays object(s) from a physical environment at a display of the device) and holding the HIPD 542. In the third AR system 500c, the wrist-wearable device 526, the MR device 532, and/or the HIPD 542 are used to interact within an MR environment, such as a VR game or other MR/VR application. While the MR device 532 presents a representation of a VR game (e.g., first MR game environment 520) to the user 502, the wrist-wearable device 526, the MR device 532, and/or the HIPD 542 detect and coordinate one or more user inputs to allow the user 502 to interact with the VR game.

In some embodiments, the user 502 can provide a user input via the wrist-wearable device 526, the MR device 532, and/or the HIPD 542 that causes an action in a corresponding MR environment. For example, the user 502 in the third MR system 500c (shown in FIG. 5C-1) raises the HIPD 542 to prepare for a swing in the first MR game environment 520. The MR device 532, responsive to the user 502 raising the HIPD 542, causes the MR representation of the user 522 to perform a similar action (e.g., raise a virtual object, such as a virtual sword 524). In some embodiments, each device uses respective sensor data and/or image data to detect the user input and provide an accurate representation of the user 502’s motion. For example, image sensors (e.g., SLAM cameras or other cameras) of the HIPD 542 can be used to detect a position of the HIPD 542 relative to the user 502’s body such that the virtual object can be positioned appropriately within the first MR game environment 520; sensor data from the wrist-wearable device 526 can be used to detect a velocity at which the user 502 raises the HIPD 542 such that the MR representation of the user 522 and the virtual sword 524 are synchronized with the user 502’s movements; and image sensors of the MR device 532 can be used to represent the user 502’s body, boundary conditions, or real-world objects within the first MR game environment 520.

In FIG. 5C-2, the user 502 performs a downward swing while holding the HIPD 542. The user 502’s downward swing is detected by the wrist-wearable device 526, the MR device 532, and/or the HIPD 542 and a corresponding action is performed in the first MR game environment 520. In some embodiments, the data captured by each device is used to improve the user’s experience within the MR environment. For example, sensor data of the wrist-wearable device 526 can be used to determine a speed and/or force at which the downward swing is performed and image sensors of the HIPD 542 and/or the MR device 532 can be used to determine a location of the swing and how it should be represented in the first MR game environment 520, which, in turn, can be used as inputs for the MR environment (e.g., game mechanics, which can use detected speed, force, locations, and/or aspects of the user 502’s actions to classify a user’s inputs (e.g., user performs a light strike, hard strike, critical strike, glancing strike, miss) or calculate an output (e.g., amount of damage)).

FIG. 5C-2 further illustrates that a portion of the physical environment is reconstructed and displayed at a display of the MR device 532 while the MR game environment 520 is being displayed. In this instance, a reconstruction of the physical environment 546 is displayed in place of a portion of the MR game environment 520 when object(s) in the physical environment are potentially in the path of the user (e.g., a collision with the user and an object in the physical environment are likely). Thus, this example MR game environment 520 includes (i) an immersive VR portion 548 (e.g., an environment that does not have a corollary counterpart in a nearby physical environment) and (ii) a reconstruction of the physical environment 546 (e.g., table 550 and cup 552). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 526, the MR device 532, and/or the HIPD 542 are described as detecting user inputs, in some embodiments, user inputs are detected at a single device (with the single device being responsible for distributing signals to the other devices for performing the user input). For example, the HIPD 542 can operate an application for generating the first MR game environment 520 and provide the MR device 532 with corresponding data for causing the presentation of the first MR game environment 520, as well as detect the user 502’s movements (while holding the HIPD 542) to cause the performance of corresponding actions within the first MR game environment 520. Additionally or alternatively, in some embodiments, operational data (e.g., sensor data, image data, application data, device data, and/or other data) of one or more devices is provided to a single device (e.g., the HIPD 542) to process the operational data and cause respective devices to perform an action associated with processed operational data.

In some embodiments, the user 502 can wear a wrist-wearable device 526, wear an MR device 532, wear smart textile-based garments 538 (e.g., wearable haptic gloves), and/or hold an HIPD 542 device. In this embodiment, the wrist-wearable device 526, the MR device 532, and/or the smart textile-based garments 538 are used to interact within an MR environment (e.g., any AR or MR system described above in reference to FIGS. 5A–5B). While the MR device 532 presents a representation of an MR game (e.g., second MR game environment 520) to the user 502, the wrist-wearable device 526, the MR device 532, and/or the smart textile-based garments 538 detect and coordinate one or more user inputs to allow the user 502 to interact with the MR environment.

In some embodiments, the user 502 can provide a user input via the wrist-wearable device 526, an HIPD 542, the MR device 532, and/or the smart textile-based garments 538 that causes an action in a corresponding MR environment. In some embodiments, each device uses respective sensor data and/or image data to detect the user input and provide an accurate representation of the user 502’s motion. While four different input devices are shown (e.g., a wrist-wearable device 526, an MR device 532, an HIPD 542, and a smart textile-based garment 538) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 538) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile-based garments 538 can be used in conjunction with an MR device and/or an HIPD 542.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 5A–5C-2 provided above are intended to augment the description provided in reference to FIGS. 1A-4B. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including executable instructions that, when executed by one or more processors, cause the one or more processors to:
while a head-wearable device is worn by a user, the head-wearable device associated with a predefined set of user interface (UI) elements:
in response to a request, from the user, to perform one or more tasks, determine whether the one or more tasks can be performed using the predefined set of UI elements;
in accordance with a determination that the one or more tasks cannot be performed using the predefined set of UI elements, cause a machine-learning algorithm to generate one or more generated UI elements based on the request;
cause the one or more generated UI elements to be presented to the user at one or more displays of the head-wearable device; and
in response to one or more user inputs directed at the one or more generated UI elements, cause the one or more tasks to be performed.

2. The non-transitory, computer-readable storage medium of claim 1, wherein the executable instructions further cause the one or more processors to:
while the head-wearable device is worn by the user:
in response to another request, from the user, to perform one or more other tasks that are distinct from the one or more tasks, determine whether the one or more other tasks can be performed using the predefined set of UI elements;
in accordance with a determination that the one or more other tasks cannot be performed using the predefined set of UI elements, cause the machine-learning algorithm to generate one or more other generated UI elements based on the other request, the one or more other generated UI elements distinct from the one or more generated UI elements;
cause the one or more other generated UI elements to be presented to the user at the one or more displays of the head-wearable device; and
in response to one or more other user inputs directed at the one or more other generated UI elements, cause the one or more other tasks to be performed.

3. The non-transitory, computer-readable storage medium of claim 1, wherein the executable instructions further cause the one or more processors to:
while the head-wearable device is worn by the user:
after causing the one or more generated UI elements to be presented to the user at the one or more displays of the head-wearable device and in response to a save command performed by the user, cause the one or more generated UI elements to be added to the predefined set of UI elements.

4. The non-transitory, computer-readable storage medium of claim 1, wherein the machine-learning algorithm further generates the one or more generated UI elements based on previous interactions between the user and one or more previous generated UI elements.

5. The non-transitory, computer-readable storage medium of claim 1, wherein the machine-learning algorithm further generates the one or more generated UI elements based on a predicted intent of the user.

6. The non-transitory, computer-readable storage medium of claim 1, wherein:
the one or more generated UI elements include at least a first generated UI element and a second generated UI element;
causing the one or more generated UI elements to be presented to the user at the one or more displays of the head-wearable device includes:
causing the first generated UI element to be presented to the user at the one or more displays of the head-wearable device; and
in response to one or more first user inputs directed at the first generated UI element, causing the second generated UI element to be presented to the user at the one or more displays of the head-wearable device; and
causing the one or more tasks to be performed is in response to one or more second user inputs directed at the second generated UI element and the one or more first user inputs directed at the first generated UI element.

7. The non-transitory, computer-readable storage medium of claim 6, wherein the machine-learning algorithm further generates the second generated UI elements based on the one or more first user inputs directed at the first generated UI element.

8. The non-transitory, computer-readable storage medium of claim 1, wherein:
the one or more generated UI elements include at least a first generated UI element and a second generated UI element;
causing the one or more generated UI elements to be presented to the user at the one or more displays of the head-wearable device includes causing the first generated UI element and the second generated UI element to simultaneously be presented to the user at the one or more displays of the head-wearable device; and
causing the one or more tasks to be performed is in response to the one or more user inputs directed at the first generated UI element and/or second generated UI element.

9. The non-transitory, computer-readable storage medium of claim 1, wherein the executable instructions further cause the one or more processors to:
while the head-wearable device is worn by the user:
in response to the one or more user inputs directed at the one or more generated UI elements, determine one or more additional tasks to be performed;
in accordance with a determination that the one or more additional tasks cannot be performed using the predefined set of UI elements, cause the machine-learning algorithm to generate one or more additional generated UI elements based on the one or more additional tasks;
cause the one or more additional generated UI elements to be presented to the user at one or more displays of the head-wearable device; and
in response to one or more additional user inputs directed at the one or more additional generated UI elements, cause the one or more additional tasks to be performed.

10. The non-transitory, computer-readable storage medium of claim 9, wherein the machine-learning algorithm further generates the additional generated UI elements based on the one or more first user inputs directed at the first generated UI element.

11. The non-transitory, computer-readable storage medium of claim 1, wherein each of the one or more generated UI elements is configured to perform a respective subtask of the one or more tasks.

12. The non-transitory, computer-readable storage medium of claim 1, wherein determining whether the one or more tasks can be performed using the predefined set of UI elements is performed by another machine-learning algorithm.

13. The non-transitory, computer-readable storage medium of claim 1, wherein each of the one or more generated UI elements is a respective type of UI element of a plurality of UI element types.

14. The non-transitory, computer-readable storage medium of claim 13, wherein the plurality of UI types includes a slider, a knob, a scrollable list, a switch, a selection display, a three-dimensional rotator, a media player, and/or an application status interface.

15. A method comprising:
while a head-wearable device is worn by a user, the head-wearable device associated with a predefined set of user interface (UI) elements:
in response to a request, from the user, to perform one or more tasks, determining whether the one or more tasks can be performed using the predefined set of UI elements;
in accordance with a determination that the one or more tasks cannot be performed using the predefined set of UI elements, generating, via a machine-learning algorithm, one or more generated UI elements based on the request;
presenting the one or more generated UI elements to the user at one or more displays of the head-wearable device; and
in response to one or more user inputs directed at the one or more generated UI elements, performing the one or more tasks.

16. The method of claim 15, further comprising:
while the head-wearable device is worn by the user:
in response to another request, from the user, to perform one or more other tasks that are distinct from the one or more tasks, determining whether the one or more other tasks can be performed using the predefined set of UI elements;
in accordance with a determination that the one or more other tasks cannot be performed using the predefined set of UI elements, generating, via the machine-learning algorithm, one or more other generated UI elements based on the other request, the one or more other generated UI elements distinct from the one or more generated UI elements;
presenting the one or more other generated UI elements to the user at the one or more displays of the head-wearable device; and
in response to one or more other user inputs directed at the one or more other generated UI elements, performing the one or more other tasks.

17. The method of claim 15, further comprising:
while the head-wearable device is worn by the user:
after causing the one or more generated UI elements to be presented to the user at the one or more displays of the head-wearable device and in response to a save command performed by the user, add the one or more generated UI elements to the predefined set of UI elements.

18. A system comprising:
a head-wearable device, the head-wearable device including one or more displays;
one or more processors; and
a memory device including executable instructions that, when executed by the one or more processors, cause the one or more processors to:
while the head-wearable device is worn by a user, wherein the head-wearable device is associated with a predefined set of user interface (UI) elements:
in response to a request, from the user, to perform one or more tasks, determine whether the one or more tasks can be performed using the predefined set of UI elements;
in accordance with a determination that the one or more tasks cannot be performed using the predefined set of UI elements, cause a machine-learning algorithm to generate one or more generated UI elements based on the request;
cause the one or more generated UI elements to be presented to the user at the one or more displays of the head-wearable device; and
in response to one or more user inputs directed at the one or more generated UI elements, cause the one or more tasks to be performed.

19. The system of claim 18, wherein the executable instructions further cause the one or more processors to:
while the head-wearable device is worn by the user:
in response to another request, from the user, to perform one or more other tasks that are distinct from the one or more tasks, determine whether the one or more other tasks can be performed using the predefined set of UI elements;
in accordance with a determination that the one or more other tasks cannot be performed using the predefined set of UI elements, cause the machine-learning algorithm to generate one or more other generated UI elements based on the other request, the one or more other generated UI elements distinct from the one or more generated UI elements;
cause the one or more other generated UI elements to be presented to the user at the one or more displays of the head-wearable device; and
in response to one or more other user inputs directed at the one or more other generated UI elements, cause the one or more other tasks to be performed.

20. The system of claim 18, wherein the executable instructions further cause the one or more processors to:
while the head-wearable device is worn by the user:
after causing the one or more generated UI elements to be presented to the user at the one or more displays of the head-wearable device and in response to a save command performed by the user, cause the one or more generated UI elements to be added to the predefined set of UI elements.
